(19) United States
(12) Patent Application Publication
(10) Pub. No.: US 2006/0121859 A1
(43) Pub. Date: Jun. 8, 2006

(54) Long distance communication system and method using the ionosphere

(75) Inventor: Sang-Hun Lee, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/295,086

(22) Filed: Dec. 6, 2005

(30) Foreign Application Priority Data
Dec. 6, 2004 (KR) 10-2004-0101572

(51) Int. Cl. H04B 1/02

(52) U.S. Cl. 455/102; 455/63.4

(57) ABSTRACT

Disclosed is a long distance communication system using the ionosphere. The long distance communication system includes an Earth station for modulating a signal having a modulation frequency onto a carrier frequency signal, which is absorbable in the ionosphere, and radiating a modulation frequency signal to a specific region of the ionosphere. The signal transmitted from the Earth station converts a DC current into an AC current in the ionosphere and the AC current re-radiates the modulation frequency signal to the Earth.

This application claims priority under 35 U.S.C. § 119 to an application entitled “Long Distance Communication System And Method Using Ionosphere” filed in the Korean Intellectual Property Office on Dec. 6, 2004 and assigned Serial No. 2004-101572, the contents of which are incorporated herein by reference.

### BACKGROUND OF THE INVENTION

1. Field of the Invention

The present invention relates to a long distance communication system and method, and more particularly, to a long distance communication system and method using the ionosphere.

2. Background of the Prior Art

The function of communication satellites is similar to that of repeater stations in land-based microwave telecommunication. The communication satellite receives signals transmitted from an Earth station, amplifies them, and retransmits the amplified signals to another Earth station.

In the late 1970's, a cellular mobile telecommunication system was developed in the United States of America. Since then, Korea began to provide a voice communication service in an Advanced Mobile Phone Service (AMPS), known as a 1st Generation (1G) analog mobile telecommunication system. In the mid 1990's, a Code Division Multiple Access (CDMA) system, known as a 2nd Generation (2G) mobile telecommunication system, was commercialized to provide voice communication and low-speed data service.

In the late 1990's, Korea partially deployed a 3rd Generation (3G) mobile telecommunication system, International Mobile Telecommunication-2000 (IMT-2000), to provide advanced wireless multimedia service, global roaming, and high-speed data service. For these telecommunication systems, an artificial satellite is needed. However, to launch the communication satellite requires enormous expenditures and continuous management.

The ionosphere is the part of the Earth's atmosphere that is located above about 50 Km from the surface of the Earth. Until now, two types of long distance communications have been made available. One is satellite communication and the other is amateur wireless (HAM) communication. Satellite communication uses a radio wave transmitted through the ionosphere, while HAM uses a radio wave reflected from the ionosphere. Long distance communication using a radio wave absorbed in the ionosphere is not known.

These prior art systems are disadvantageous because the satellite communication system requires an enormous expenditure, and the HAM can only accommodate voice communication, and not high-capacity information.

### SUMMARY OF THE INVENTION

The present invention provides a long distance communication system and method using the ionosphere.

The present invention also provides a long distance communication system and method using a radio wave absorbed in the ionosphere.

In addition, the present invention provides a long distance communication system and method using a DC current within the ionosphere.

Further, the present invention provides a long distance communication system and method using a temperature change within the ionosphere.

According to an aspect of the present invention, a long distance communication system using the ionosphere includes an Earth station for modulating a signal having a modulation frequency onto a carrier frequency signal, which is absorbable in the ionosphere, and radiating a modulation frequency signal to a specific region of the ionosphere, wherein the signal transmitted from the Earth station converts a DC current into an AC current in the ionosphere and the AC current re-radiates the modulation frequency signal to the Earth.

The Earth station may include a mixer for mixing the modulation frequency signal and the carrier frequency signal to generate an RF signal; an amplifier for amplifying the RF signal to a predetermined power enough to allow the RF signal to reach the ionosphere; and a directional antenna for radiating an output signal of the amplifier to the specific region of the ionosphere.

Preferably, the carrier frequency is in a range from several MHz to 2 GHz, while the modulation frequency is in a range of several MHz lower than the carrier frequency. The signal transmitted from the Earth station is preferably accumulated as an energy within the ionosphere and changes an electron temperature, and the DC current is converted into the AC current depending on the change of the electron temperature. Additionally, the AC current preferably oscillates at a frequency equal to the modulation frequency.

According to another aspect of the present invention, a long distance communication method using the ionosphere includes modulating a signal having a modulation frequency onto a carrier frequency signal, which is absorbable in the ionosphere, and radiating a modulation frequency signal from an Earth station to a specific region of the ionosphere; and re-radiating the modulation frequency signal to the Earth by an AC current, which is converted from a DC current in the ionosphere due to the signal transmitted from the Earth station.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a simulation result showing a change of an electric field depending on a change of an electron temperature within the ionosphere;

FIG. 2 illustrates a concept of a long distance communication system using the ionosphere according to an embodiment of the present invention; and

FIG. 3 illustrates an apparatus for transmitting signals from the Earth station to the ionosphere according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. A detail description of well-known features will be omitted for conciseness.

DC current, called an ionosphere current, spontaneously flows in the ionosphere. Thus, if a modulation frequency signal is modulated onto a carrier frequency and is transmitted to the ionosphere, the DC current of the ionosphere is converted into an AC current that oscillates with the modulation frequency. The AC current serves as an antenna to re-radiate the modulation frequency signal to the Earth.

The principle of converting the DC current into the AC current within the ionosphere will now be described.

An electrojet current in the ionosphere is expressed as Equation (1) below:
Jₑ=−en₀uₑ=(n₀e²E₀/m)(\hat{x}vₑₙ−ŷΩₑ)/(vₑₙ²+Ωₑ²) (1)

where vₑₙ represents an electron-neutral collision frequency.

The electron-neutral collision frequency vₑₙ is proportional to an electron temperature Tₑ (vₑₙ∝Tₑ). If a special energy is not applied to the ionosphere, there is no change in the electron temperature. Therefore, both the electron-neutral collision frequency vₑₙ and the electron temperature Tₑ become constant and thus the electrojet current becomes the DC current.

Meanwhile, the relationship between an electron temperature Tₑ in a specific region of the ionosphere and an energy Q transmitted from the Earth station to the specific region is defined by a following electron thermal energy equation.
∂Tₑ/∂t(2Tₑ/3)∇·vₑ+δ(Tₑ)vₑ(Tₑ)(Tₑ−Tₙ)+ionization loss=(2/3n₀)Q (2)

In Equation 2, if the modulation frequency signal (e.g., QPSK) is modulated onto the carrier frequency and is transmitted to the specific ionosphere, the energy Q is accumulated in the ionosphere and the electron temperature Tₑ is oscillating depending on the accumulated energy. The energy is generally expressed as the square of modulation frequency signal. Accordingly, the energy changes depending on the information (modulation frequency) modulated onto the carrier frequency. The temperature Tₑ in the ionosphere is oscillating depending on the change IN energy. Since vₑₙ∝Tₑ, the electron-neutral collision frequency vₑₙ is also oscillating and the DC current is converted into the AC current having the modulation frequency, as expressed in Equation (1).

The AC current serves as a dipole antenna to re-radiate the information signal (modulation frequency signal) to the Earth. A magnetic field B is expressed as Equation (3):
B(R,t)=[G₀/(1+bχ^{5/3})](χ^{5/6}∂_{T}lnχ) (3)

where G₀ and b are constant and χ is Tₑ/Tₑ₀ that is the normalized electron temperature.

Since the physical meaning of Equations (1) to (3) is disclosed in “Gurevich, V. A. (1978), Nonlinear Phenomena in the Ionosphere, Springer-Verlag, N.Y.”, a detailed description thereof will be omitted here.

As described above, if the modulation frequency signal is modulated onto the carrier frequency and is transmitted to the specific region of the ionosphere, the electron temperature in the ionosphere is oscillating at a frequency equal to the modulation frequency depending on the change of the energy Q. Consequently, the DC current spontaneously flowing in the ionosphere is converted into AC current. The AC current serves as an antenna to re-radiate the modulation frequency signal to the Earth.

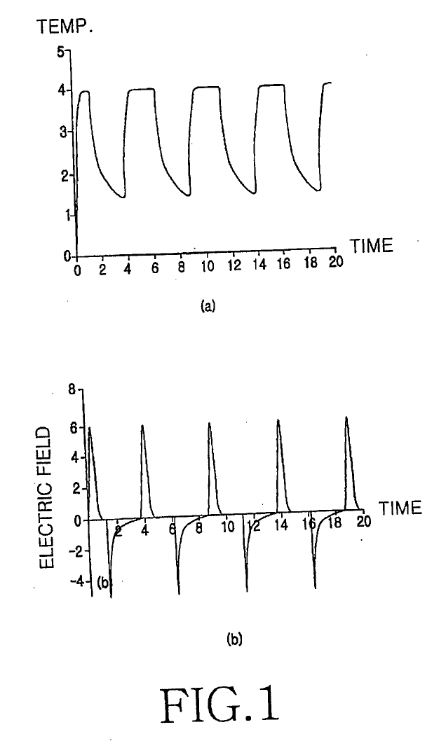

FIG. 1 is a simulation result showing a change of an electric field depending on a change of a temperature Tₑ within the ionosphere. FIG. 1(a) illustrates the change of the temperature Tₑ with respect to time, and FIG. 1(b) illustrates the electric field depending on the change of the temperature Tₑ. When the electron temperature in the ionosphere is oscillating, the electric field is also oscillating in proportion to the electron temperature.

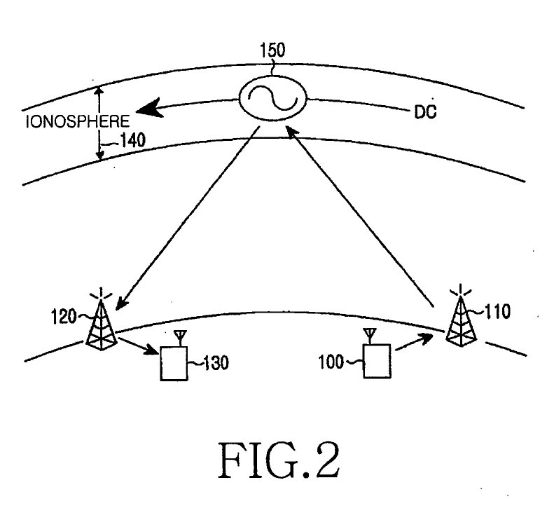

FIG. 2 illustrates the concept of a long distance communication system using the ionosphere according to an embodiment of the present invention. Referring to FIG. 2, a first Earth station 110 receives signals from a mobile station or network device 100 (e.g., BTS, BSC, MSC) of a mobile communication system in a wired or wireless manner and modulates the received signals onto a carrier frequency signal (e.g., several hundred MHz to several GHz), which can be absorbed in the ionosphere, and then transmits the modulation signals to a specific region 150 of the ionosphere 140. In this case, a power amplifier having a large maximum output power is used for allowing the transmitted signals to reach the ionosphere 140. Also, a directional antenna is preferably used for radiating the signals to the specific region 150 of the ionosphere 140.

The signals transmitted from the first Earth station 110 convert the DC current into the AC current in the ionosphere 140. Then, the AC current in the ionosphere 140 re-radiates the signals to the Earth. A second Earth station 120 receives the signals radiated from the ionosphere 140 and transmits the received signals to a corresponding mobile station or network device 130 (e.g., BTS, BSC, MSC).

Although FIG. 2 illustrates that the Earth stations perform unidirectional communication, the Earth stations actually perform bidirectional communication. In addition, although FIG. 2 illustrates that the Earth stations communicate with the mobile stations, the Earth stations can also communicate with other network devices (e.g., BTS, BSC, MSC). Hereinafter, it is assumed that the Earth stations communicate with the mobile stations.

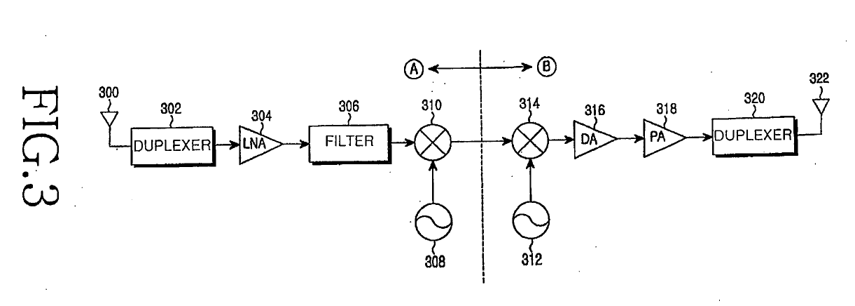

FIG. 3 illustrates an apparatus for transmitting the signals from the Earth station to the ionosphere according to an embodiment of the present invention. Referring to FIG. 3, the Earth station is divided into two parts, that is, a part A for communicating with the mobile communication system and a part B for transmitting signals to the ionosphere. Part A includes a first antenna 300, a first duplexer 302, a low noise amplifier (LNA), a filter 306, a first mixer 310, and a first local oscillator 308. Part B includes a second local oscillator 312, a second mixer 314, a drive amplifier (DA) 316, a power amplifier (PA) 318, a second duplexer 320, and a second antenna 322.

The Earth station receives a signal from the mobile station through the first antenna 300. The first duplexer 302 performs a band filtering on the signal received through the first antenna 300. Since the received signal contains spurious frequency components, it is band-pass filtered so as to amplify only a desired frequency band.

The low noise amplifier 304 amplifies an output signal of the duplexer 302 while suppressing noise. The filter 306 performs a band filtering on an output signal of the low noise amplifier 304 so as to remove fatal image frequency and spurious frequency components.

The first local oscillator 308 supplies the first mixer 310 with a local oscillating (LO) frequency, which is used to remove the carrier frequency from the received signal. The first mixer 310 mixes the output signal of the filter 306 with the LO frequency. In this manner, the carrier frequency used in the mobile communication system is removed from the received signal.

The second local oscillator 312 supplies the second mixer 314 with carrier frequencies, which can be absorbed in the ionosphere. The second mixer 314 mixes an output signal of the first mixer 310 (a signal containing a modulation frequency signal) with the carrier frequencies from the second local oscillator 312. In transmitting a signal to a satellite, the carrier frequency of several GHz is commonly used. The reason is that the signal is difficult to pass through the ionosphere without any influence if the carrier frequency is below several GHz. Meanwhile, if the carrier frequency is several MHz, the signal is totally reflected from the ionosphere. Accordingly, the carrier frequency is preferably several hundred MHz to 2 GHz.

The drive amplifier 316 compensates for gain of the power amplifier 318 and amplifies an output of the second mixer 314 so as to provide sufficient input power to the power amplifier 318. The power amplifier 318 amplifies a power of an RF signal outputted from the drive amplifier 316 so that the RF signal can reach the ionosphere.

The second duplexer 320 performs a band filtering on an output signal of the power amplifier 318 to remove spurious frequency components. The second antenna 322 is preferably a directional antenna that transmits an output signal of the second duplexer 320 to a specific region of the ionosphere. The transmitted signal is absorbed in the ionosphere and converts the DC current into the AC current therein. The AC current is re-radiated to the Earth.

In FIG. 3, the output signal of the first mixer 310 may be an Intermediate Frequency (IF) signal or a Base-Band (BB) signal. If the output signal of the first mixer 310 is the BB signal, the first mixer 310 and the second mixer 314 are provided with direct conversion devices that directly convert the RF and baseband signals.

In another embodiment, the RF signal received from the mobile station is converted into the BB signal through the IF signal, and the BB signal is then converted into the RF signal through the IF signal. Then, the RF signal is transmitted to the ionosphere.

According to an embodiment of the present invention, the long distance communication using the ionosphere can be provided by optimizing the carrier frequency and signal intensity (output level of the power amplifier) of the signal transmitted to the ionosphere. The carrier frequency uses the frequency band that can be absorbed in the ionosphere, and the power amplifier only needs to have enough output power to allow the transmitted signal to reach the ionosphere. The long distance communication using the ionosphere according to an embodiment of the present invention removes the burden of using a satellite.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A long distance communication system using the ionosphere, comprising:
an Earth station for modulating a signal having a modulation frequency onto a carrier frequency signal, which is absorbable in the ionosphere, and radiating a modulation frequency signal to a specific region of the ionosphere,
wherein the modulation frequency signal Earth converts a DC current into an AC current in the ionosphere and the AC current re-radiates the modulation frequency signal to the Earth.

2. The long distance communication system of claim 1, wherein the Earth station includes:
a mixer for mixing the modulation frequency signal and the carrier frequency signal to generate an RF signal;
an amplifier for amplifying the RF signal; and
a directional antenna for radiating an output signal of the amplifier to the specific region of the ionosphere.

3. The long distance communication system of claim 1, wherein the carrier frequency is in a range of several MHz to 2 GHz.

4. The long distance communication system of claim 1, wherein the modulation frequency is several MHz lower than the carrier frequency.

5. The long distance communication system of claim 1, wherein the signal transmitted from the Earth station is accumulated as energy within the ionosphere and changes an electron temperature, and the DC current is converted into the AC current depending on the change of the electron temperature.

6. The long distance communication system of claim 1, wherein the AC current oscillates at a frequency equal to the modulation frequency.

7. A long distance communication method using the ionosphere, comprising the steps of:
modulating a signal having a modulation frequency onto a carrier frequency signal, which is absorbable in the ionosphere, and radiating a modulation frequency signal from an Earth station to a specific region of the ionosphere; and
re-radiating the modulation frequency signal to the Earth by an AC current, which is converted from a DC current in the ionosphere due to the modulation frequency signal Earth.

8. The long distance communication method of claim 7, wherein the step of re-radiating the modulation frequency signal includes the steps of:
mixing the modulation frequency signal and the carrier frequency signal to generate an RF signal;
amplifying the RF signal; and
directionally radiating an output signal of the amplifier to the specific region of the ionosphere.

9. The long distance communication method of claim 7, wherein the carrier frequency is in a range of several MHz to 2 GHz.

10. The long distance communication method of claim 7, wherein the modulation frequency is several MHz lower than the carrier frequency.

11. The long distance communication method of claim 7, wherein the signal transmitted from the Earth station is accumulated as energy within the ionosphere and changes an electron temperature, and the DC current is converted into the AC current depending on the change of the electron temperature.

12. The long distance communication method of claim 7, wherein the AC current oscillates at a frequency equal to the modulation frequency.

13. A long distance communication system using the ionosphere, comprising:
an Earth station for modulating a signal having a modulation frequency onto a carrier frequency signal, which is absorbable in the ionosphere, and radiating a modulation frequency signal to a specific region of the ionosphere;
wherein the ionosphere re-radiates the modulation frequency signal to the Earth by means of an AC current that is converted from a DC current by the signal transmitted from the Earth station.

14. The long distance communication system of claim 13, wherein the Earth station includes:
a mixer for mixing the modulation frequency signal and the carrier frequency signal to generate an RF signal;
an amplifier for amplifying the RF signal; and
a directional antenna for radiating an output signal of the amplifier to the specific region of the ionosphere.

15. The long distance communication system of claim 13, wherein the carrier frequency is in a range of several MHz to 2 GHz.

16. The long distance communication system of claim 13, wherein the modulation frequency is several MHz lower than the carrier frequency.

17. The long distance communication system of claim 13, wherein the signal transmitted from the Earth station is accumulated as energy within the ionosphere and changes an electron temperature, and the DC current is converted into the AC current depending on the change of the electron temperature.
